(19) United States
(12) Patent Application Publication
(10) Pub. No.: US 2026/0065068 A1
(43) Pub. Date: Mar. 5, 2026

(54) ELICITING BLACK-BOX REPRESENTATIONS FROM MACHINE LEARNING MODELS THROUGH SELF-QUERIES

(71) Applicants: Robert Bosch GmbH, Stuttgart (DE); Carnegie Mellon University, Pittsburgh, PA (US)

(72) Inventors: Dylan Jiang SAM, Pittsburgh, PA (US); Marc FINZI, Pittsburgh, PA (US); Jeremy KOLTER, Pittsburgh, PA (US); Devin T. WILLMOTT, Pittsburgh, PA (US); Wan-Yi LIN, Wexford, PA (US)

(21) Appl. No.: 18/819,217

(22) Filed: Aug. 29, 2024

(51) Int. Cl. G06N 3/094; G06F 40/284; G06F 40/40

(52) U.S. Cl. CPC G06N 3/094; G06F 40/284; G06F 40/40

(57) ABSTRACT

Methods for determining black-box representations of machine learning models when information pertaining to internal states or parameters of the models are not accessible are disclosed. By using outputs of the model instead of internal states, the black-box representation is model-agnostic and provides a reliable and robust representation of the model using an external lens. The black-box representation is generated using responses from the model to a series of initialization and elicitation questions that quantify the confidence that the model has in answers it just returned. The black-box representation is then used as a training dataset for a linear classifier in order to learn performance metrics about the model.

### TECHNICAL FIELD

The present disclosure relates to the concept of “explainability” as related to machine learning (ML) models.

### BACKGROUND

Large language models (LLMs) have demonstrated strong performance on a wide variety of tasks, leading to their increased involvement in larger systems. For instance, they are often used to provide supervision or as tools in decision-making. Thus, it is crucial to understand and predict their behaviors, especially in high-stakes settings. Existing work on understanding LLMs is to leverage their ability to interact with human queries. While significant progress has been made on these fronts, these approaches require white-box access to these models (e.g., access to the model's activations or hidden states). However, many of the best-performing LLMs, such as GPT4, lie beyond closed-source APIs, so these prior attempts to understand model behavior cannot be applied.

### SUMMARY

The present disclosure generates a representation of a machine learning model that does not rely on using internal states, hidden states, weights, biases, or other internal parameters of the model in order to generate the representation. Using a series of initialization and elicitation questions that are provided to the given model, the systems and methods described herein determine a black-box representation of the model based on responses to those questions. As the representation of the model is based on outputs of the model itself and not on internal parameters of the model, the representation that is generated is completely “black-box.” The black-box representation may then be provided to a linear classifier or other downstream machine learning model as a training dataset in order to learn performance related data about the machine learning model, such as confidence metrics.

### BRIEF DESCRIPTION OF THE DRAWINGS

FIG. 1 illustrates a system for training and utilizing a machine learning model, such as a linear classifier, according to some embodiments.

FIG. 2 illustrates a computer-implemented method for training and utilizing a machine learning model, such as a linear classifier, according to some embodiments.

FIG. 3 illustrates a service provider network that is configured to interact with and analyze performance of various machine learning models that are external to the service provider network, according to some embodiments.

FIG. 4 is a flow diagram that illustrates a process of using initialization and elicitation questions as a guide to generate a black-box representation of a machine learning model, according to some embodiments.

FIG. 5A is a flow diagram that illustrates providing the black-box representation introduced in FIG. 4 to a linear classifier for use in determining a performance score of the machine learning model, according to some embodiments.

FIG. 5B is a flow diagram that illustrates providing the black-box representation introduced in FIG. 4 to a linear classifier for use in determining which version of the machine learning model the service provider network is interacting with, according to some embodiments.

FIG. 5C is a flow diagram that illustrates providing the black-box representation introduced in FIG. 4 to a linear classifier for use in determining that the machine learning model has been negatively influenced by adversarial prompt(s) by user(s).

FIG. 6 illustrates results of using the black-box representations to determine performance scores of various machine learning models when prompting the machine learning model with open-ended question-answer type initialization and elicitation questions, according to some embodiments.

FIG. 7 illustrates results of using the black-box representations to determine performance scores of various machine learning models when prompting the machine learning model with multiple-choice or true/false question-answer type initialization and elicitation questions, according to some embodiments.

FIG. 8A illustrates results of varying a confidence threshold of the linear classifier using black-box representations vs. answer probabilities for a first machine learning model, according to some embodiments.

FIG. 8B illustrates results of varying a confidence threshold of the linear classifier using black-box representations vs. answer probabilities for a second machine learning model, according to some embodiments.

FIG. 9 illustrates results pertaining to the use of a linear classifier, trained on the black-box representations, for distinguishing between a clean version of a given machine learning model and a version of the given machine learning model that has been influenced by an adversary, according to some embodiments.

FIG. 10A illustrates a t-distributed stochastic neighbor embedding (T-SNE) pertaining to the use of the black-box representations for reliably distinguishing between multiple versions of a given large language model, according to some embodiments.

FIG. 10B illustrates a T-SNE pertaining to the use of the black-box representations for reliably distinguishing between multiple versions of another given large language model, according to some embodiments.

FIG. 11 illustrates results pertaining to the use of a linear classifier, trained on the black-box representations, for distinguishing between multiple versions of a given large language model, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Large language models (LLMs) have demonstrated strong performance on a wide variety of tasks, leading to their increased involvement in larger systems. For instance, they are often used to provide supervision or as tools in decision-making. Thus, it is crucial to understand and predict their behaviors, especially in high-stakes settings. However, as with any deep network, it is difficult to understand or explain the behavior of such large models. For instance, prior work has studied input gradients or saliency maps to attempt to understand neural network behavior, but this can fail to reliably describe model behavior. Other prior work has studied the ability of transformers to represent certain algorithms that may be involved in their predictions.

One promising direction in understanding LLMs (or any other multimodal model that understands natural language) is to leverage their ability to interact with human queries. However, while some progress has been made on these fronts, these approaches all require “white-box” access levels to these models (e.g., access to the model's activations or hidden states), and many of the best-performing LLMs at the time of writing lie beyond closed-source APIs. Thus, these prior art methods to understand model behavior cannot be applied.

In order to address these challenges, the present disclosure includes methods for eliciting responses from the machine learning model by querying the model about its initial responses. That data is then used to determine a “black-box” representation, wherein outputs of the model, and not internal parameters of the model, are applied. Such methods ensures that the black-box representation is both model-agnostic and that said methods can be applied to closed-source models.

Such black-box representations provide a useful low-dimensional representation that can then be used to train reliable and generalizable predictors or other linear classifiers on performance of the LLM (e.g., assessing performance on classification tasks or text generation tasks). As demonstrated herein with quantifiable results, the black-box representation method matches and even outperforms linear predictors that have been trained using white-box representations to operate over the LLM's hidden state.

In addition to predicting LLM performance, these extracted black-box representations are also useful for a variety of other applications in assessing the state of a LLM. For instance, the methods and systems described herein demonstrate that the black-box representations can be used to almost perfectly detect when an LLM has been adversarially influenced by a system prompt, as compared to a clean version of this model. The black-box representations may be further applied to reliably distinguish between different model architectures and model sizes, and this is useful in evaluating if cheaper or smaller models are falsely being provided through these closed-source APIs as opposed to the authentic model.

The following description continues with a general introduction to machine learning techniques that are relevant to the methods for determining black-box representations described herein. Next, various embodiments of computing system and linear classifier based architectures are discussed. The present disclosure then demonstrates the versatility of the methods and systems described herein by providing quantified results of the use of the present disclosure to various implementations and scenarios.

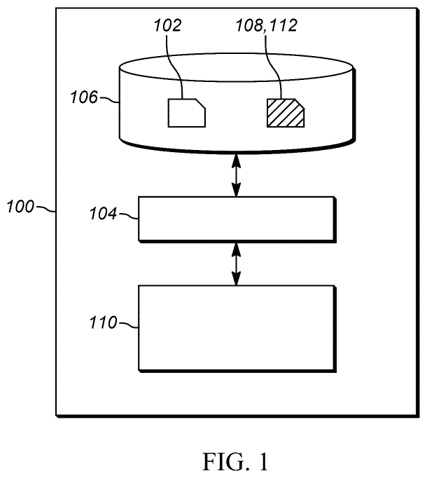

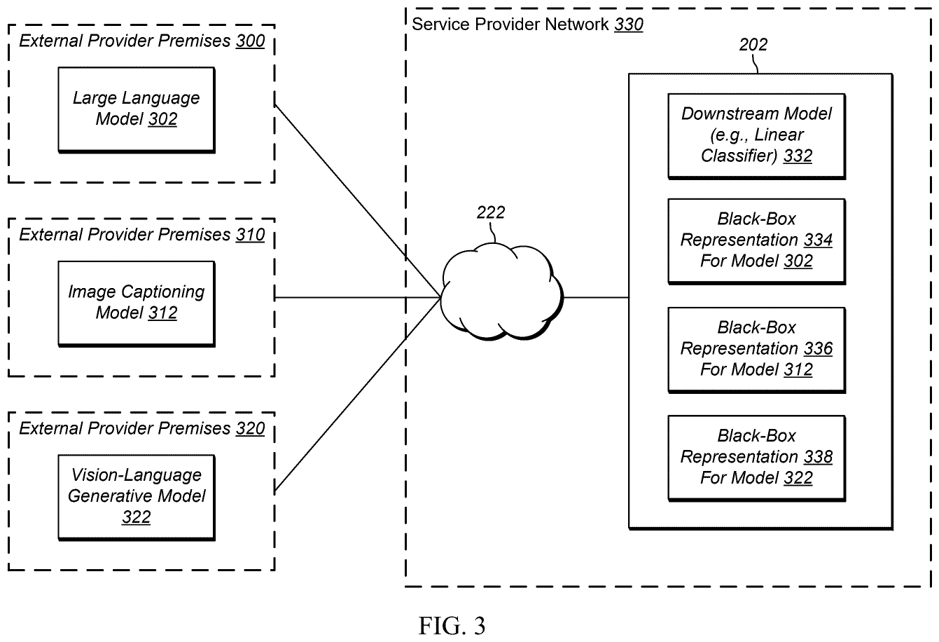

FIG. 1 illustrates a system 100 for training and utilizing a linear classifier, such as a simple, linear classifier. It should be understood that, while the example embodiments in the description that follows mainly refers to a linear classifier for ease of discussion, additional embodiments of the present disclosure may be applied to any other type of machine learning model that is configured to be developed, trained, and optimized for providing performance data of ML models using black-box representations, such as a neural network, a deep neural network, a machine learning model configured to perform regression tasks, or any other type of predictor model. Also for ease of discussion herein, the “predictor” model may also be referred to as a downstream machine learning model or an internal machine learning model in order to distinguish between this model that is within a service provider network (e.g., downstream model 332, shown in FIG. 3) and one or more other machine learning models that are outside of the logically designated service provider network (e.g., LLM 302, image captioning model 312, and vision-language generative model 322, also shown in FIG. 3).

Moreover, and as related to the description herein, a “deep” learning model, such as a deep neural network, may be defined as having multiple hidden layers (e.g., one, two, or tens of hidden layers) in between an input layer and an output layer of the model. A deep learning model may additionally be used to describe a machine learning model that is configured to learn complex patterns and representations based on training and/or validation datasets that are used as inputs to the deep learning model.

Additional embodiments pertaining to such types of machine learning models are described herein with regard to machine learning model 332 and blocks 412, 502, 504, 522, 524, 542, and 544.

In some embodiments, the system 100 may comprise an input interface for accessing training data 102 for the linear classifier. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the untrained linear classifier may also each be accessed from a different data storage, e.g., via a different subsystem of the data storage interface 104. Each subsystem may be of a type as is described above for the data storage interface 104. In other embodiments, the data representation 108 of the untrained linear classifier may be internally generated by the system 100 on the basis of design parameters for the linear classifier, and therefore may not explicitly be stored on the data storage 106. The system 100 may further comprise a processor subsystem 110 which may be configured to, during operation of the system 100, provide an iterative function as a substitute for a stack of layers of the linear classifier to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the linear classifier using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the linear classifier. The system 100 may further comprise an output interface for outputting a data representation 112 of the trained linear classifier, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ linear classifier may during or after the training be replaced, at least in part by the data representation 112 of the trained linear classifier, in that the parameters of the linear classifier, such as weights, hyperparameters, and other types of parameters of linear classifiers, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘untrained’ linear classifier. In some embodiments, the output interface may be separate from the data storage interface 104, but may in general be of a type as described above for the data storage interface 104.

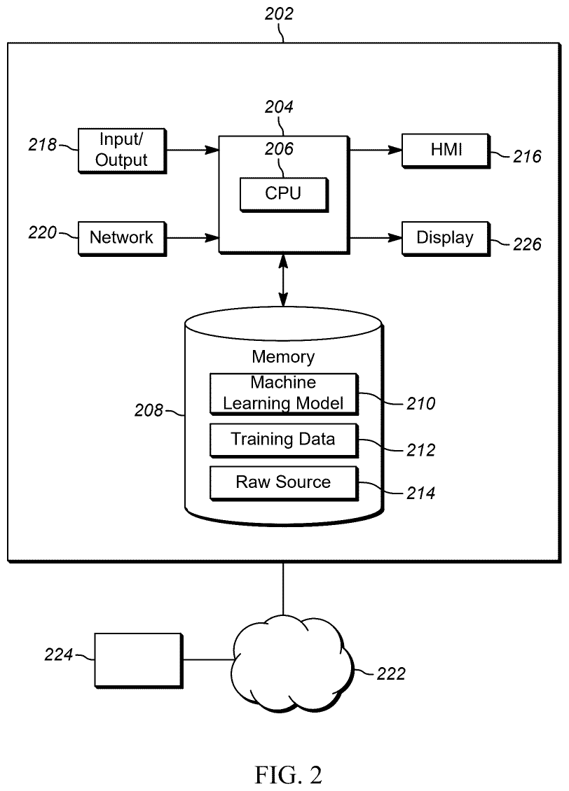

FIG. 2 illustrates a computer-implemented method for training and utilizing a linear classifier, according to some embodiments. The system may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 214, etc.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222. As additionally illustrated in FIG. 3, external network 222 may allow secure information and data to be exchanged between computing system 202 and servers 224 within a service provider network 330, while also providing communication capabilities with external computing devices that are outside of the secure designation of the service provider network. In such embodiments, network 222 may resemble two separate communication portals, thus distinguishing between secure communication links and non-secure communication links.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 202 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 202 may implement a machine learning algorithm 210 that is configured to analyze the raw source dataset 214. The raw source dataset 214 may include raw or unprocessed sensor data that may be representative of an input dataset for a machine learning system. In some examples, the machine learning algorithm 210 may be a linear classifier algorithm that is designed to perform a predetermined function. For example, the linear classifier algorithm may be configured to learn patterns pertaining to machine learning model and based on black-box representations of those models in order to output performance data of the models.

The computer system 202 may store a training dataset 212 for the machine learning algorithm 210. The training dataset 212 may represent a set of previously constructed data for training the machine learning algorithm 210, such as black-box representations of machine learning models and real or simulated top-k probabilities of the models. The training dataset 212 may be used by the machine learning algorithm 210 to learn weighting factors associated with a linear classifier algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature (e.g., an atomic system comprising water molecules has evidence of hydrogen and oxygen). The raw source data 214 may be derived from a variety of sources. For example, the raw source data 214 may be actual input data collected by a machine learning system. The raw source data 214 may be machine generated for testing the system.

In the example, the machine learning algorithm 210 may then process raw source data 214 and output performance metrics, indications of which version of a machine learning model within a “family” of models the linear classifier is receiving data from, or whether or not the given machine learning model has been tampered with by an adversarial input. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

FIG. 3 illustrates a service provider network that is configured to interact with and analyze performance of various machine learning models that are external to the service provider network, according to some embodiments.

In some embodiments, computing system 202 and servers 224 may be located within one or more premises of a service provider network, such as service provider network 330. Various premises of service provider network 330 may resemble multiple physical locations, such as multiple data centers, and thus service provider network 330 refers to a logical designation wherein computing devices located at the various premises may communicate securely with one another, such as through network 222. As such, when computing system 202 communicates with other computing devices outside of the logical designation of service provider network 330, the communication may or may not be secure.

Throughout the description herein, computing devices and machine learning models that are referred to as being external or externally located to service provider network 330 thus refer to computing devices and machine learning models of other third party providers that computing system 202 is configured to communicate with, such as via network 222. For example, LLM 302 may refer to one or more computing devices that are located at external provider premises 300, such as a data center of the external provider, and that are configured to execute LLM 302. Similarly, image captioning model 312 may refer to one or more computing devices that are located at external provider premises 310 and that are configured to execute image captioning model 312, and vision-language generative model 322 may refer to one or more computing devices that are located at external provider premises 320 and that are configured to execute vision-language generative model 322.

As introduced above, the external providers of LLM 302, image captioning model 312, and vision-language generative model 322 may or may not provide information pertaining to internal states, hidden states, weights, biases, or other confidential information about the models to users of the models. Thus, computing system 202 may be configured to implement a machine learning model analysis service that generates black-box representations of machine learning models of external providers. For example, computing system 202 may determine a black-box representation 334 of LLM 302, a black-box representation 336 of image captioning model 312, and a black-box representation 322 of vision-language generative model 322. Black-box representations 334, 336, and 338 may then be used to generate training datasets for linear classifier 332, which is then trained to output performance data about the respective models.

In addition to the components of computing system 202 that are illustrated in FIG. 2, computing system 202 may also include a machine learning model, such as linear classifier 332 that is configured to analyze other machine learning models using black-box representations. As introduced above and as additionally illustrated in FIG. 3, the following description refers to model 332 as being implemented as a linear classifier. However, the “downstream” model 332 that is located within service provider network 330 may also refer to a neural network, a deep neural network, a machine learning model configured to perform regression tasks, or any other type of predictor model that is configured to take black-box representations as inputs to learn performance data about LLM 302, image captioning model 312, or vision-language generative model 322.

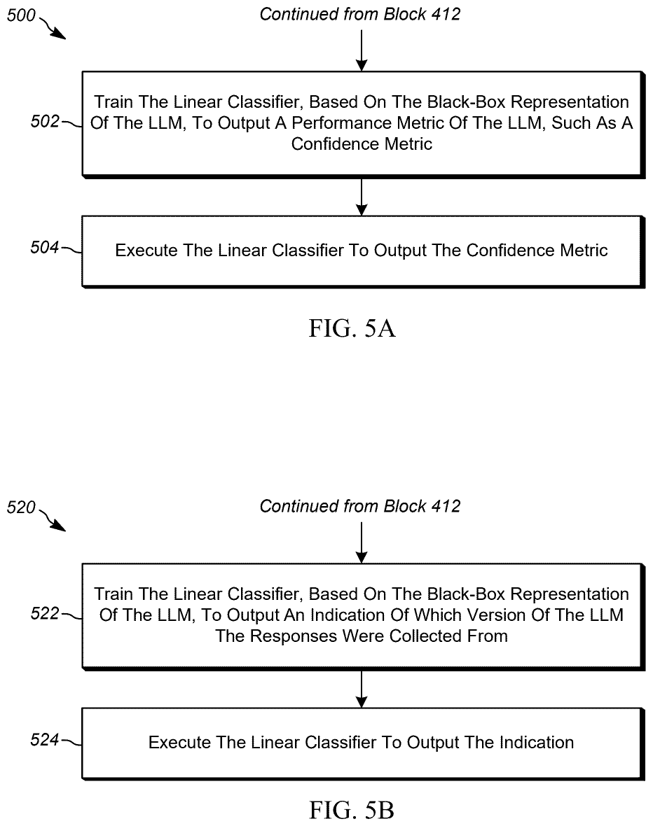

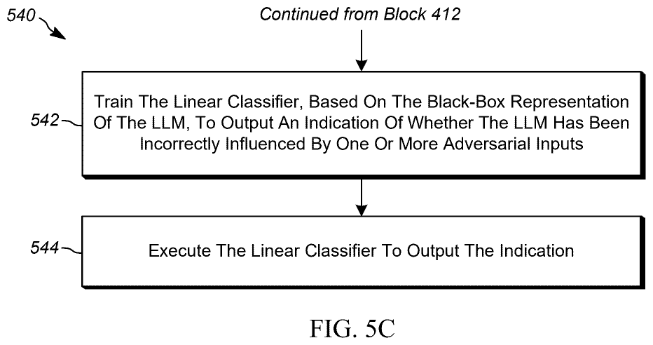

For ease of discussion herein, linear classifier 332 is referred to as a single linear classifier model. However, it should be understood that black-box representation 334 for LLM 302 is used to generate a training dataset for a first linear classifier, which is then trained to output performance data that is specific to LLM 302, while black-box representation 336 for image captioning model 312 is used to generate a training dataset for a second linear classifier, which is then trained to output performance data that is specific to image captioning model 312, and black-box representation 338 for vision-language generative model 322 is used to generate a training dataset for a third linear classifier, which is then trained to output performance data that is specific to vision-language generative model 322. Examples of performance data that is determined from an execution of linear classifier 332 is additionally discussed with regard to FIGS. 5A-5C herein.

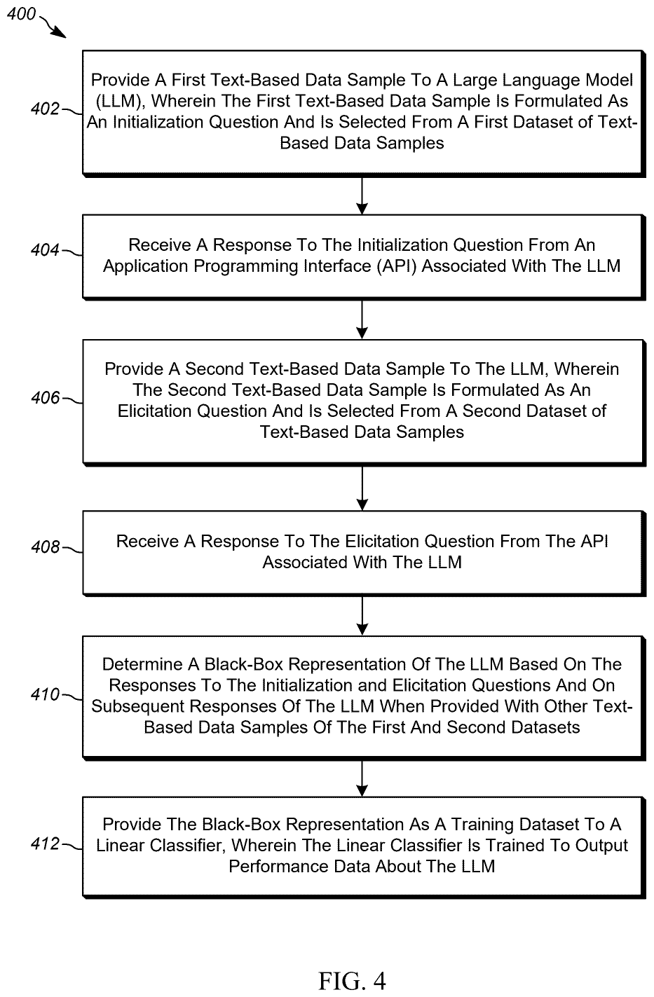

FIG. 4 is a flow diagram that illustrates a process of using initialization and elicitation questions as a guide to generate a black-box representation of a machine learning model, according to some embodiments.

Process 400 corresponds to a computer-implemented method that may be executed by computing system 202, according to some embodiments. The following paragraphs describe a given implementation of process 400 wherein the machine learning model that computing system 202 is generating a black-box representation for corresponds to LLM 302, located at external provider premises 300. Other embodiments of process 400 that correspond to a different machine learning model, such as image captioning model 312 or vision-language generative model 322 may similarly be applied from the description herein.

In some embodiments, blocks 402-408 refer to process steps that may be used to gather data about LLM 302 that is then used to determine the black-box representation of LLM 302.

Prior to a moment in time corresponding to the processing step shown in block 402, a first dataset of text-based data samples may be generated, wherein the text-based data samples are formulated as initialization questions that will be sent to LLM 302 as initial prompts. Depending upon particular implementations of LLM 302, initialization questions may be formatted as multiple choice questions, True/False questions, open-ended questions, or any other type of question that prompts a quantitative response from LLM 302. For example, a given text-based data sample may comprise tokens that, when combined, formulate any of the following initialization questions: “Is today Tuesday?”; “Is today Tuesday, yes or no?”; “Is today Monday, Tuesday, or Wednesday?”; “Today is Tuesday—True or False?”

In block 402, a first initialization question is provided to LLM 302 via network 222. For ease of discussion herein, this particular implementation of process 400 will use the example of the initialization question “Is today Tuesday?” being provided to LLM 302.

In block 404, computing system 202 receives a response from LLM 302 to the initialization question via an application programming interface, located at external provider premises 300. For ease of discussion herein, this particular implementation of process 400 will use the example of the response to the initialization question that is received being “Yes.”

Prior to a moment in time corresponding to block 406, a second dataset of text-based data samples may be generated, wherein the text-based data samples are formulated as elicitation questions that will be sent to LLM 302 as prompts regarding the confidence that LLM 302 has in the answer to the initialization question it just provided. Elicitation questions refer to text-based data samples that are structured as self-inquiry questions that pertain to the model's confidence or belief in its answer that it has responded with.

Elicitation questions are formatted in such a way as to prompt one of two binary-type responses from LLM 302. For example, elicitation questions may prompt “yes” or “no” type responses, “1” or “0” type responses, or any other similar variation. Examples of text-based samples that comprise tokens that, when combined, may resemble the following, or any similar variation of the following: “Do you think your answer is correct?”; “Are you confident in your answer?”; “Would you change your answer?”; “Are you not confident in your answer?”; “Are you sure?”; “Are you certain?”; “Are you positive?”; “Are you sure about that?”; “Are you able to explain your answer?”

In some embodiments, generating a wide variety of elicitation questions may lead to more useful black-box representations, as this allows computing system 202 to capture more information from the LLM, more complex information from LLM, or more complete information from LLM. As additionally discussed below, however, regardless of the size of the second dataset that is formulated as elicitation questions, the elicitation questions and responses to those elicitation questions are treated as abstract features by linear classifier 332, thus ensuring that linear classifier 332 is task-agnostic.

In block 406, a first elicitation question is provided to LLM 302 via network 222. For ease of discussion herein, this particular implementation of process 400 will use the example of the initialization question “Do you think your answer is correct?” being provided to LLM 302.

In block 408, computing system 202 receives a response from LLM 302 to the elicitation question via an application programming interface, located at external provider premises 300. For ease of discussion herein, this particular implementation of process 400 will use the example of the response to the elicitation question that is received being “Yes.”

Processing steps shown in blocks 402-408 may then be repeated a plurality of times, wherein a new initialization question from the first dataset is provided to LLM 302, a response is returned, then a new elicitation question from the second dataset is provided to LLM 302, and a response is returned. Conducting the processing steps shown in blocks 402-408 multiple times allows for enough information to be collected from LLM 302 for a dataset on the scale of a training dataset for linear classifier 332 to be generated.

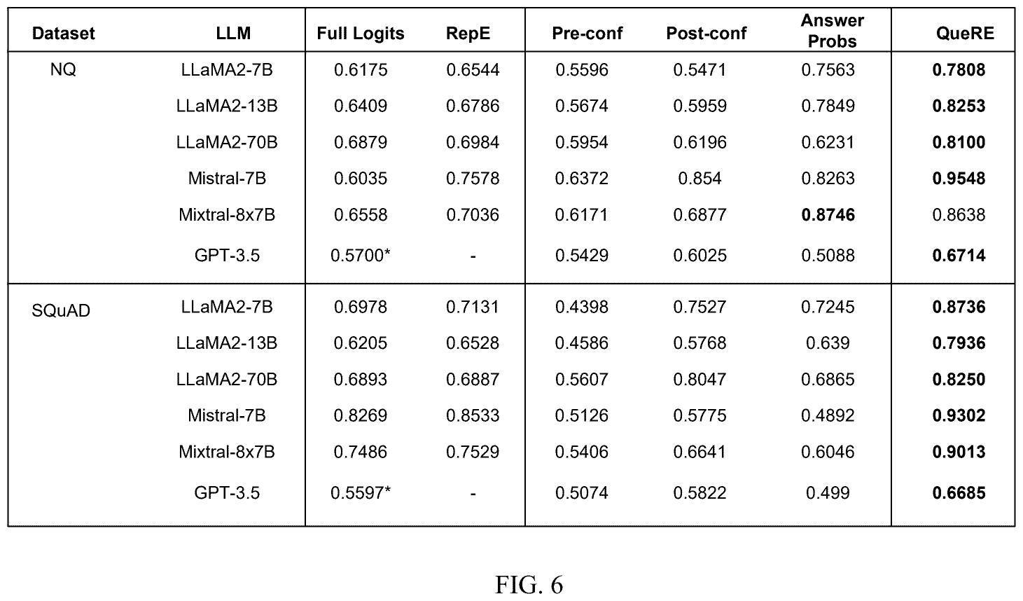

In addition, other embodiments of process 400 may provide a given initialization question and a given elicitation question to LLM 302 concurrently. For example, the following text-based data samples may be provided to LLM 302 at a given moment in time: “Is today Tuesday? Are you sure about your answer?” In such embodiments, LLM 302 may then respond “Yes, today is Tuesday. Yes.” Embodiments in which initialization questions and elicitation questions are prompted to LLM 302 sequentially (e.g., first the initialization question, then the elicitation question after receiving the response to the initialization question) allows for post-confidence scores to be calculated and additionally applied as inputs to linear classifier 332, while embodiments in which initialization and elicitation questions are prompted to LLM 302 concurrently (e.g., wherein a response to both the initialization question and the elicitation question are then received concurrently) allows for pre-confidence scores to be calculated and additionally applied as inputs to linear classifier 332. FIGS. 6, 7, 9 and 11 additionally illustrate this concept.

Returning to the flow diagram illustrated in FIG. 4, block 410 refers to a moment in time after which point at least several responses to initialization and elicitation questions have been received and stored within computing system 202. Computing system 202 then determines a black-box representation 334 for LLM 302 using those responses. As introduced above, the determination of the black-box representation is conducted without knowledge of internal states, hidden states, weights, biases, or other internal information about LLM 302, and is instead determined using the responses by the model to the initialization and elicitation questions. This determination of the black-box representation is “black-box” as the model's outputs are used to determine the representation, as opposed to a “white-box” representation which would include information about the internal states, hidden states, weights, biases, etc. of the model.

In some embodiments, generating a black-box representation may resemble the following: LLM 302 is provided with a first dataset of text-based samples that are formulated as initialization questions, wherein the initialization questions may be written as D={x₁, . . . , xₙ} where xᵢ is a sequence of tokens. The greedy response of LLM 302 (e.g., a greedy response referring to the temperature parameter being set to zero) may then be written as

$${a}_{i} = arg {max}_{c} P ( c \vert {x}_{i} ) .$$

Elicitation questions that are provided to LLM 302 may be written as Q={q₁, . . . , q_{d}}. The black-box representation that is determined may then resemble probabilities of receiving a first of the two binary response options (e.g., receiving a “yes” instead of a “no,” or “True” instead of “False,” etc.) from the API of the LLM when provided with a given initialization question and a given elicitation question of the first dataset, D, and second dataset, Q, respectively. A corresponding black-box representation may then be written as some vector z=(z₁, . . . , z_{d}), wherein zⱼ=P(yes|x⊕a⊕qⱼ), and ⊕ denotes concatenation. Continuing with the above example, dimensions of the black-box representation correspond to the probability of receiving the “yes” token from LLM 302 instead of the “no” token in response to initialization question x, greed sampled response a to the initialization question, and elicitation question qⱼ.

Returning again to process 400 shown in FIG. 4, block 412 illustrates that black-box representation 334 is then provided as a training dataset to linear classifier 332, wherein linear classifier 332 is then trained on that training dataset and is configured to output performance data about LLM 302 for future use by the ML model analysis service. Additional description pertaining to types of performance data that may be output by linear classifier 332 is discussed herein with regard to FIGS. 5A, 5B, and 5C.

In some embodiments, the black-box representation 334 that has been determined by computing system 202 is directly provided as a training dataset for linear classifier 332. In other embodiments, additional data may be appended to the data within black-box representation 334, prior to providing both the additional data and the black-box representation 334 as a combined training dataset. For example, some external providers may make public some data such as top-k probabilities of their ML model. In another example, computing system 202 may compute pre-confidence scores and/or post-confidence scores, based on the responses received to initialization and elicitation questions.

Referring firstly to embodiments in which additional data is appended to the black-box representation 334 and the additional data is top-k probabilities, one of two process flows may be organized by computing system 202: If, for instance, computing system 202 requests data pertaining to top-k probabilities about LLM 302 from external provider 300, and external provider 300 subsequently provides these top-k probabilities about LLM 302, that additional data may be incorporated into the training dataset for linear classifier 332. If, in another example, computing system 202 requests data pertaining to top-k probabilities about LLM 302 and external provider 300 does not provide these top-k probabilities about LLM 302, computing system 202 may be configured to perform high-temperature sampling of LLM 302 in order to generate simulated top-k probabilities about LLM 302, and then incorporate the simulated top-k probabilities about LLM 302 into the training dataset.

As referred to herein, “top-k probabilities” may be defined as a parameter that measures the probability that the machine learning model will return a token within k most likely options of tokens. When available for use by computing system 202, top-k probabilities may provide additional information that may be of use to linear classifier 332, as top-k probabilities may act as a signature that computing system 202 was interacting with a particular updated version of LLM 302 vs an outdated version of LLM 302 when prompting LLM 302 with initialization and elicitation questions.

In addition, “high-temperature sampling,” as referred to herein, may be defined as a method for flattening or sharpening a probability distribution over the number of tokens k being sampled. The high-temperature sampling that is used to generate the simulated top-k probabilities may be executed by computing system 202, by some machine learning model that computing system 202 has access to, or by linear classifier 332, according to some embodiments.

Referring secondly to embodiments in which additional data is appended to the black-box representation 334 and the additional data is pre-confidence scores or post-confidence scores, then the following procedure(s) may be organized by computing system 202. In embodiments introduced above in which computing system 202 may provide a given initialization question and a given elicitation question to LLM 302 concurrently (e.g., text-based data samples “Is today Tuesday? Are you sure about your answer?” are provided simultaneously to LLM 302 at a given moment in time), then computing system 202 may determine a pre-confidence score based on at least LLM's responses to the elicitation questions. That calculated pre-confidence score may then be appended to the black-box representation, such that the resulting training dataset for linear classifier 322 includes both the black-box representation and the pre-confidence score. In other embodiments introduced above in which computing system 202 may provide a given initialization question and a given elicitation question to LLM 302 sequentially (e.g., text-based data samples “Is today Tuesday?” are first provided to LLM 302 as an initialization question, then, following the response of LLM 302 to the initialization question, text-based data samples “Are you sure about your answer?” are provided as an elicitation question at a later moment in time), then computing system 202 may determine a post-confidence score based on at least LLM's responses to the elicitation questions. That calculated post-confidence score may then be appended to the black-box representation, such that the resulting training dataset for linear classifier 322 includes both the black-box representation and the post-confidence score.

The “pre-confidence” score refers to a confidence score that reflects a moment in time prior to LLM 302 having been asked a self-inquiry question (e.g., a moment in time that refers to after the initialization question has been asked, but before an elicitation question has been asked). In contrast, the “post-confidence” score refers to a confidence score that reflects a moment in time after LLM 302 has been asked a self-inquiry question (e.g., a moment in time that refers to after the initialization question has been asked, and after an elicitation question has been asked). The calculation of pre-confidence and/or post-confidence scores by computing system 202 may be of interest to include into the subsequent training dataset for linear classifier 322 because it may result in more robust and comprehensive performance data being output by linear classifier 322 once it has been trained.

Returning to the overall process flow 400 shown in FIG. 4, in some embodiments in which process 400 is applied to image captioning model 312 or vision-language generative model 322 instead of to LLM 302, then initialization “questions” may instead resemble image-based data samples that are then provided to model 312 or model 322. Model 312 or model 322 then returns text-based responses to those initialization questions. Moreover, in some embodiments in which process 400 is applied to image captioning model 312 or vision-language generative model 322 instead of to LLM 302, elicitation questions may still resemble text-based data samples that are then provided to model 312 or model 322. Model 312 or model 322 then returns text-based responses to those elicitation questions.

FIG. 5A is a flow diagram that illustrates providing the black-box representation introduced in FIG. 4 to a linear classifier for use in determining a performance score of the machine learning model, according to some embodiments.

The following description pertaining to FIGS. 5A, 5B, and 5C will continue to refer to embodiments in which computing system 202 is interacting with LLM 302 in order to determine performance data about LLM 302 for the ML model analysis service. It should be understood, however, that other embodiments pertaining to interactions with image captioning model 312, vision-language generative model 322, or any other machine learning model that outputs text-based data samples are also encompassed in the discussion herein.

Process 500 may be considered as an extension of process 400, wherein computing system 202 has determined a black-box representation 334 for LLM 302 and used that black-box representation to generate a training dataset for linear classifier 332. Block 502 depicts training linear classifier 332 on the training dataset, wherein linear classifier 332 is being trained to output one or more performance metrics about LLM 302. The performance metric may resemble a performance score that provides a quantitative value of how confident LLM 302 is in its responses or how likely LLM 302 is to respond correctly to question prompts by users.

Block 504 then reflects a moment in time after linear classifier has been trained on the training dataset, and may be executed in order to provide the performance metric to the ML model analysis service.

FIG. 5B is a flow diagram that illustrates providing the black-box representation introduced in FIG. 4 to a linear classifier for use in determining which version of the machine learning model the service provider network is interacting with, according to some embodiments.

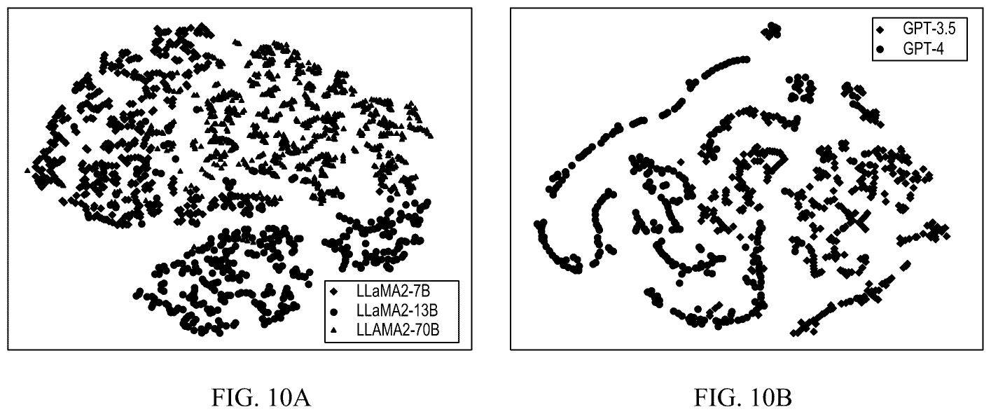

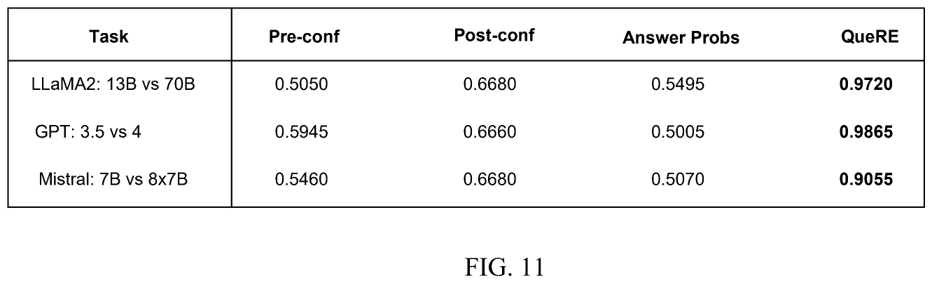

Process 520 may be considered as an extension of process 400, wherein computing system 202 has determined a black-box representation 334 for LLM 302 and used that black-box representation to generate a training dataset for linear classifier 332. Block 522 depicts training linear classifier 332 on the training dataset, wherein linear classifier 332 is being trained to output an indication of which version of LLM 302 the initialization and elicitation questions were provided to. For example, and as additional described with regard to FIGS. 10A, 10B, and 11 herein, linear classifier 332 may be configured to determine whether computing system 202 is interacting with LLaMA2-7B, LLaMA2-13B, or LLaMA2-70B. In another example, linear classifier 332 may be configured to determine whether computing system 202 is interacting with GPT-3.5 or GPT-4. In order for linear classifier 332 to learn such performance data about LLM 302, multiple training datasets may be provided to the linear classifier, such that it may be trained to detect patterns within the data based on responses to various initialization questions and elicitation questions.

Block 524 then reflects a moment in time after linear classifier has been trained on the training dataset(s), and may be executed in order to provide the indication of the particular version of LLM 302 that computing system 202 has been interacting with to the ML model analysis service for future use by users of the service.

FIG. 5C is a flow diagram that illustrates providing the black-box representation introduced in FIG. 4 to a linear classifier for use in determining that the machine learning model has been negatively influenced by adversarial prompt(s) by user(s).

Process 540 may be considered as an extension of process 400, wherein computing system 202 has determined a black-box representation 334 for LLM 302 and used that black-box representation to generate a training dataset for linear classifier 332. Block 522 depicts training linear classifier 332 on the training dataset, wherein linear classifier 332 is being trained to output an indication of whether or not it is likely that LLM 302 has been corrupted or otherwise influence by adversarial inputs to the model. As defined for the present disclosure herein, corruption of the machine learning model, attack onto the model, incorrect influence onto the model, negative influence onto the model, or intentional influence onto the model may refer to inputs or methods used by other users of the LLM 302 that cause either intentional or unintentional misclassification or misdirection of the overall machine learning model. For example, due to adversarial or malicious inputs to the machine learning model, the model may be misguided such that it is biased towards generate hateful responses or towards providing incorrect responses. The methods and systems described herein may be used to identify such attacks, thus enabling the ML model analysis service to alert users of the given ML model, or shutdown use by users within the service provider network 330 to the given ML model, etc.

Block 544 then reflects a moment in time after linear classifier has been trained on the training dataset(s), and may be executed in order to provide the indication that LLM 302 has or has not been somehow tampered with or maliciously influenced to the ML model analysis service for future use in alerting users of the service.

In the remaining portion of the present disclosure, the following definitions may be applied: Question Representation Elicitation (QueRE) may refer to the computer-implemented methods described herein of obtaining data to determine a black-box representation of a given ML model and subsequently training a linear classifier on the black-box representation. In the following figures and corresponding description, QueRE is compared to RepE and to Full Logits, both of which are prior art methods of generating white-box representations of various ML models, rather than the present disclosure's methods of generating black-box representations of various ML models. RepE, for example, extracts a hidden state of a given LLM at the last token position, while Full Logits uses the distribution over the LLM's entire vocabulary, thus defining both RepE and Full Logits as white-box representations instead of as black-box representations.

Furthermore, abbreviations such as “pre-conf scores” and “post-conf scores” within FIGS. 6, 7, 9, and 11 refer to “pre-confidence scores” and “post-confidence scores,” as introduced above as being univariate features that correspond to the probability of the “yes” token being received from LLM 302 in response to an elicitation question about LLM's confidence in their response to the initialization question either before (“pre”) or after (“post”) returning the greedy response to the initialization question. The abbreviation “Answer Probs” within FIGS. 6, 7, 8A, 8B, 9, and 11 also refers to a normalized probability distribution over potential answer questions, and is used to compare against QueRE. Answer Probs provides a baseline comparison in order to provide quantitative results pertaining to how much of an increase in performance is obtained by QueRE by adding additional elicitation questions and/or concatenating them together to be provided concurrently to LLM 302.

Moreover, and in the following figures and corresponding descriptions, QueRE is also compared against: “HaluEval,” a prior art method of detecting hallucinations; “DHate,” a prior art method of detecting toxic comments; “CS QA,” a prior art method of detecting commonsense reasoning; and other prior art baselines used for comparison against QueRE, such as “NQ,” “SQuAD,” “BoolQ,” and “WinoGrande.”

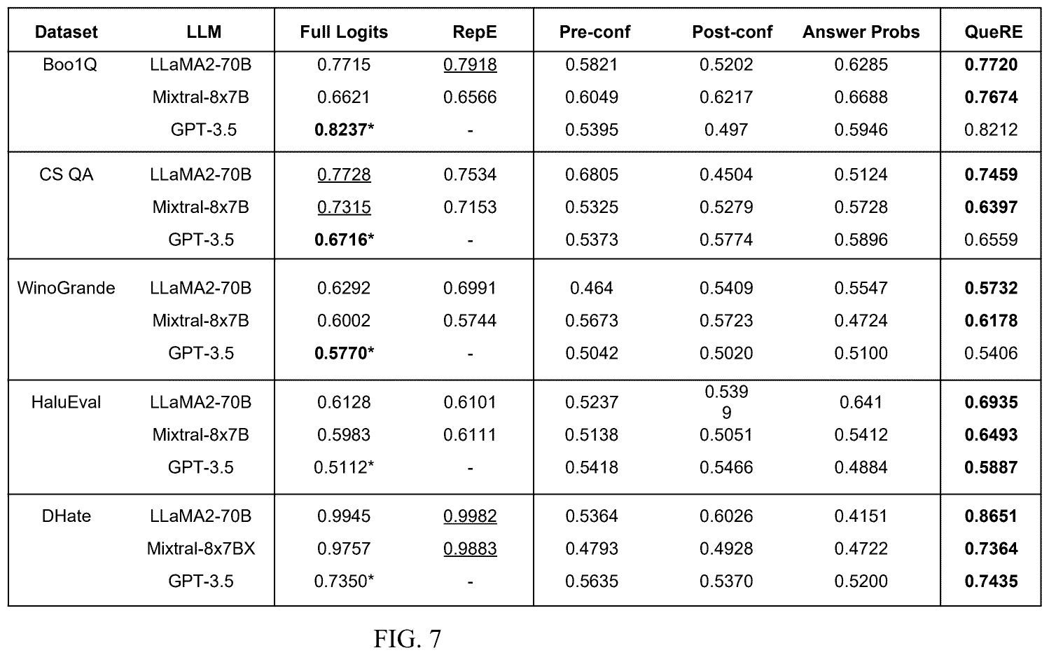

FIG. 6 illustrates results of using the black-box representations to determine performance scores of various machine learning models when prompting the machine learning model with open-ended question-answer type initialization and elicitation questions, while FIG. 7 illustrates results of using the black-box representations to determine performance scores of various machine learning models when prompting the machine learning model with multiple-choice or true/false question-answer type initialization and elicitation questions, according to some embodiments.

As shown in both FIG. 6 and FIG. 7, the linear classifier that has been trained on black-box representations is used to predict performance of various ML models of corresponding external networks based on open-ended question-answer tasks in FIG. 6 and on binary or multiple choice question-answer tasks with the largest ML model from each model “family” in FIG. 7. Such embodiments of training the linear classifier to output performance data about various ML models has additionally been discussed above with regard to FIG. 5A.

As shown in FIG. 6, the table illustrates AUROC in predicting model performance on open-ended, question-answer tasks. The best resulting method, QueRE or otherwise, is indicated using bold text in the figure, while “−” denotes that RepE cannot be applied in that particular instance. Furthermore, “*” denotes that Full Logits for GPT-3.5 is a sparse vector with nonzero values for the top-5 logits from the API.

As shown in FIG. 7, the table illustrates AUROC in predicting model performance on multiple-choice questions and on True/False tasks. The best resulting method, QueRE or otherwise, is indicated using bold text in the figure, and underlined text denotes the best white-box, prior-art method when it outperforms black-box approaches. Furthermore, “−” denotes that RepE cannot be applied in that particular instance and “*” denotes that Full Logits for GPT-3.5 is a sparse vector with nonzero values for the top-5 logits from the API.

As illustrated in FIGS. 6 and 7, the present disclosure methods of generating performance data about ML models using black-box representations out-performs prior-art, white-box representations in a vast majority of tasks and significantly outperforms the simpler approaches of using confidence scores or only the answer probabilities. Specifically, QueRE regularly outperforms RepE and Full Logits, which are both baselines that assume access to more information about the given ML model and which are frequently not available for many closed-source LLMs.

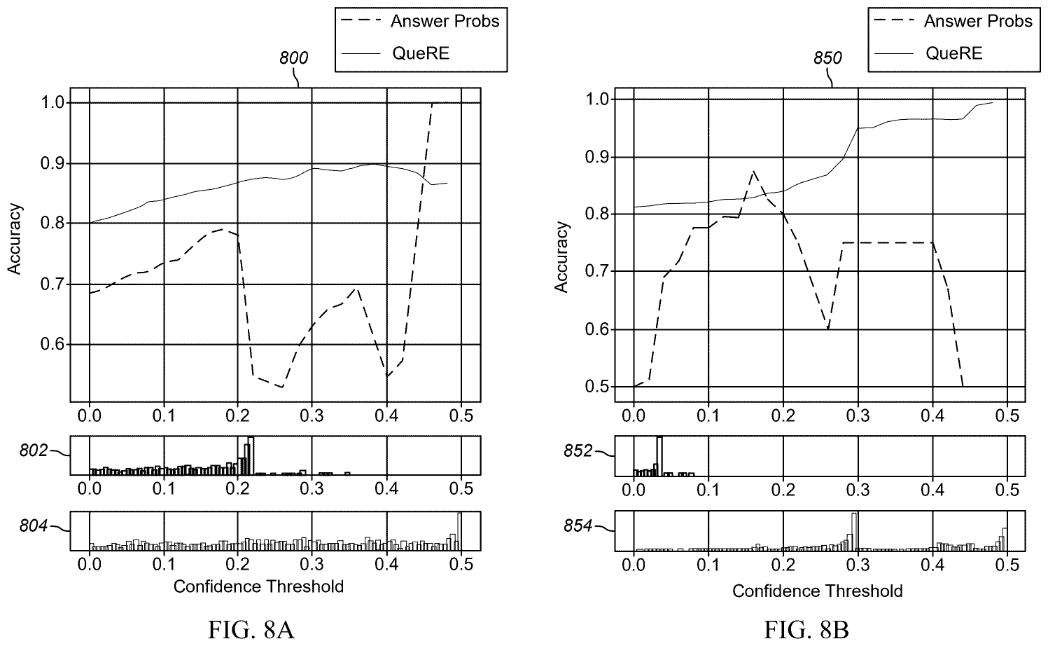

FIGS. 8A and 8B illustrate results of varying a confidence threshold of the linear classifier using black-box representations vs. answer probabilities for respective machine learning models, according to some embodiments. Such embodiments of training the linear classifier to output performance data about various ML models has additionally been discussed above with regard to FIG. 5A.

FIG. 8A illustrates accuracy along the y-axis vs confidence threshold at which predictions are made along the x-axis in plot 800 for both QueRE and Answer Probs of LLaMA2-70B on SQuAD, as indicated by the key in the figure. Plots 802 and 804 depict the variation in confidence threshold for QueRE and for LLaMA2-70B, respectively. In addition, the confidence threshold may be defined as the difference from random confidence (e.g., 0.5), thus enabling the histograms in plots 802 and 804 which are distributions over confidence levels.

FIG. 8B illustrates accuracy along the y-axis vs confidence threshold at which predictions are made along the x-axis in plot 850 for both QueRE and Answer Probs of Mixtral-8x7B on SQuAD, as indicated by the key in the figure. Plots 852 and 854 depict the variation in confidence threshold for QueRE and for Mixtral-8x7B, respectively. In addition, the confidence threshold may be defined as the difference from random confidence (e.g., 0.5), thus enabling the histograms in plots 852 and 854 which are distributions over confidence levels.

As shown in both FIGS. 8A and 8B, QueRE depicts a more calibrated predictor, with close to monotonic improvements in accuracy as the confidence threshold is increased.

FIGS. 8A and 8B also demonstrate the use of QueRE in selective prediction (e.g., predicting when over a certain confidence threshold). This is particularly applicable for high-stakes settings, prediction by an LLM may be deferred until a certain level of confidence in its performance can be quantified and confirmed. QueRE defines a predictor that is better calibrated than the white-box representation prior-art methods, due to the close to monotonic improvements in accuracy as the confidence threshold is increased. As such, QueRE demonstrates methods and systems for providing well-calibrated and performant predictors of LLM performance, thus broadening the applicability and reliability of LLMs in many useful, high-stakes settings.

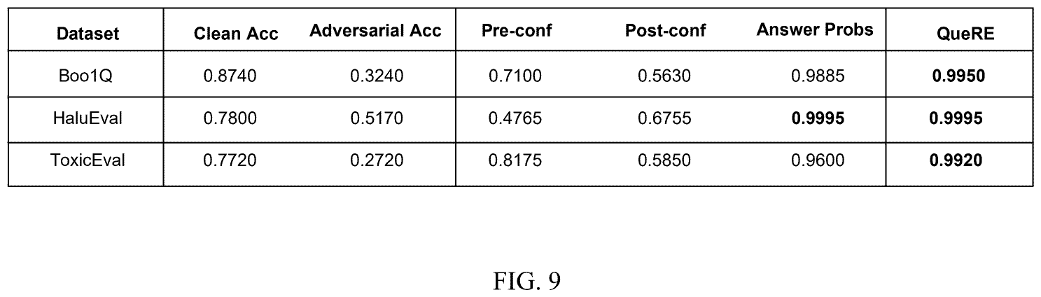

FIG. 9 illustrates results pertaining to the use of a linear classifier, trained on the black-box representations, for distinguishing between a clean version of a given machine learning model and a version of the given machine learning model that has been influenced by an adversary, according to some embodiments. Such embodiments of training the linear classifier to output indications of whether or not various ML models have been tampered with has additionally been discussed above with regard to FIG. 5C.

As shown in FIG. 9, QueRE can reliably distinguish between an untampered with version of an LLM (e.g., “Clean Acc”) and a tampered with version of an LLM (e.g., “Adversarial Acc”), wherein Adversarial Acc represents an LLM that has been influenced by an adversary. In the left two columns of the table, the results indicate that performance of the given ML model drops significantly when using an adversarial system prompt, thus ensuring that QueRE can reliably detect when such an attack has occurred.

FIGS. 10A and 10B illustrate a T-SNE pertaining to the use of the black-box representations for reliably distinguishing between multiple versions of respective large language models, according to some embodiments. In addition, FIG. 11 illustrates results pertaining to the use of a linear classifier, trained on the black-box representations, for distinguishing between multiple versions of a given large language model, according to some embodiments. Such embodiments of training the linear classifier to output indications of which version of an ML model “family” has additionally been discussed above with regard to FIG. 5B.

The T-SNE diagrams in both figures are generated from results using SQuAD. As depicted in FIG. 10A and in the corresponding Key of the figure, QueRE is able to correctly map 1000 samples to interactions from LLaMA2-7B, LLaMA2-13B, and LLaMA2-70B within the LLaMA2 model family. As depicted in FIG. 10B and in the corresponding Key of the figure, QueRE is able to correctly map 1000 samples to interactions from GPT-3.5 and GPT-4 within the GPT model family.

As illustrated via the respective clusters in FIGS. 10A and 10B, QueRE can reliably distinguish between different versions within an LLM family. This suggests that the distributions learned by different LLMs behave in distinct ways, even when the same architecture and training objectives are used and the variable is instead the model size. FIG. 11 additionally provides experimentally results that use the linear classifier to classify respective black-box representations as corresponding to different versions within a given LLM family. It may be observed that linear classifiers that are trained on black-box representations using systems and methods described herein near perfectly classify respective versions of LLMs of different sizes. Applications of the systems and methods described herein may therefore be implemented in order to reliably detect whether or not a falsified version of the real ML model has been provided through an API.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for analyzing a large language model (LLM), comprising:
providing, via computing devices of a service provider network, a first text-based data sample to the LLM, wherein the first text-based data sample is formulated as an initialization question and is selected from a first dataset of text-based data samples;
receiving, from an Application Programming Interface (API) associated with the LLM, data indicating a response to the initialization question;
providing a second text-based data sample to the LLM, wherein the second text-based data sample is formulated as an elicitation question and is selected from a second dataset of text-based data samples;
receiving, from the API associated with the LLM, data indicating a response to the elicitation question, wherein the response to the elicitation question is one of two binary response options;
determining a black-box representation of the LLM based on the data indicating the responses to the initialization and elicitation questions and on data indicating subsequent responses of the LLM when provided with other text-based data samples of the first and second datasets; and
providing the black-box representation as a training dataset to a linear classifier, wherein the linear classifier is trained to output performance data about the LLM.

2. The computer-implemented method of claim 1, wherein the black-box representation comprises probabilities of receiving a first of the two binary response options from the API associated with the LLM when provided with a given initialization question and a given elicitation question of the first and second datasets, respectively.

3. The computer-implemented method of claim 1, wherein the determining of the black-box representation does not rely on internal states, hidden states, weights, biases, or other internal parameters of the LLM.

4. The computer-implemented method of claim 1, wherein the LLM is located externally to the service provider network.

5. The computer-implemented method of claim 1, further comprising generating the second dataset of text-based data samples, wherein the text-based data samples of the second dataset are formulated to elicit information about accuracy or confidence from the LLM and to prompt binary-type responses from the LLM.

6. The computer-implemented method of claim 1, further comprising:
providing a request to the API associated with the LLM for data indicating top-k probabilities of the LLM; and
determining the black-box representation of the LLM additionally based on the data indicating the top-k probabilities.

7. The computer-implemented method of claim 1, further comprising:
determining that data indicating top-k probabilities of the LLM are not available for request;
performing high-temperature sampling of the LLM to generate simulated top-k probabilities; and
determining the black-box representation of the LLM additionally based on the simulated top-k probabilities.

8. The computer-implemented method of claim 1, further comprising:
calculating a post-confidence score of the LLM, wherein the calculated post-confidence score provides a probability of receiving a first of the two binary response options from the API associated with the LLM when provided with the text-based data samples of the second dataset; and
providing the black-box representation in addition to the calculated post-confidence score as the training dataset to the linear classifier.

9. The computer-implemented method of claim 1, further comprising:
training the linear classifier, based on the black-box representation of the LLM, to output an indication of which version of the LLM the responses were collected from; and
executing the linear classifier to output the indication.

10. The computer-implemented method of claim 1, further comprising:
training the linear classifier, based on the black-box representation of the LLM, to output an indication of whether the LLM has been incorrectly influenced by one or more adversarial inputs; and
executing the linear classifier to output the indication.

11. A computer-implemented method for analyzing a large language model (LLM), comprising:
providing, via computing devices of a service provider network, text-based data samples of a first dataset and of a second dataset to the LLM, wherein:
text-based data samples of the first dataset are formulated as initialization questions; and
text-based data samples of the second dataset are formulated as elicitation questions;
receiving, from an Application Programming Interface (API) associated with the LLM, data indicating responses to the initialization questions and to the elicitation questions, wherein the data indicating the responses to the elicitation questions are one of two binary response options;
determining a black-box representation of the LLM based on the data indicating the responses; and
providing the black-box representation as a training dataset to a linear classifier, wherein the linear classifier is trained to output performance data about the LLM.

12. The computer-implemented method of claim 11, wherein the black-box representation comprises probabilities of receiving a first of the two binary response options from the API associated with the LLM when provided with a given initialization question and a given elicitation question of the first and second datasets, respectively.

13. The computer-implemented method of claim 11, wherein the LLM is located externally to the service provider network.

14. The computer-implemented method of claim 11, wherein:
when providing the text-based data samples of the first and second datasets to the LLM, a given initialization question is provided concurrently with a given elicitation question; and
the method further comprises:
calculating a pre-confidence score of the LLM, wherein the calculated pre-confidence score provides a probability of receiving a first of the two binary response options from the API associated with the LLM when provided with the text-based data samples of the second dataset; and
providing the black-box representation in addition to the calculated pre-confidence score as the training dataset to the linear classifier.

15. The computer-implemented method of claim 11, wherein:
when providing the text-based data samples of the first and second datasets to the LLM, a given elicitation question is provided sequentially after receiving the response to the given initialization question; and
the method further comprises:
calculating a post-confidence score of the LLM, wherein the calculated post-confidence score provides a probability of receiving a first of the two binary response options from the API associated with the LLM when provided with the text-based data samples of the second dataset; and
providing the black-box representation in addition to the calculated post-confidence score as the training dataset to the linear classifier.

16. The computer-implemented method of claim 11, further comprising:
providing a request to the API associated with the LLM for data indicating top-k probabilities of the LLM; and
determining the black-box representation of the LLM additionally based on the data indicating the top-k probabilities.

17. A system, comprising:
computing devices of a service provider network configured to implement a Machine Learning (ML) model analysis service, wherein the ML model analysis service is configured to:
provide data samples of a first dataset and of a second dataset to an external ML model, located externally to the service provider network, wherein data samples of the second dataset are text-based data samples and are formulated as elicitation questions;
receive, from an Application Programming Interface (API) associated with the external ML model, data indicating responses to the data samples of the first dataset and to the elicitation questions, wherein the data indicating the responses to the elicitation questions are one of two binary response options;
determine a black-box representation of the external ML model based on the data indicating the responses;
provide the black-box representation as a training dataset to an internal ML model, located internally to the service provider network; and
executing the internal ML model to output performance data about the external ML model.

18. The system of claim 17, wherein:
the external ML model is a Vision-Language Generative Model or an Image Captioning Model; and
the data samples of the first dataset are image-based data samples.

19. The system of claim 17, wherein:
the external ML model is a Large Language Model; and
the data samples of the first dataset are text-based data samples.

20. The system of claim 17, wherein the internal ML model is a linear classifier or a neural network.
